(19) United States
(12) Patent Application Publication
(10) Pub. No.: US 2004/0026366 A1
(43) Pub. Date: Feb. 12, 2004

(54) Method of manufacturing ultra-precise, self-assembled micro systems

(76) Inventors: Andre Sharon, Newton, MA (US); Holger Wirtz, Erkath (DE)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/432,768

(22) PCT Filed: Nov. 28, 2001
(86) PCT No.: PCT/US01/44757

(51) Int. Cl. B44C 1/22

(52) U.S. Cl. 216/52

(57) ABSTRACT

A technique for fabricating precisely machined micro devices and micro systems that facilitates the fabrication of three-dimensional device features and reduces the need for final micro assembly. The technique includes providing a layer of base material on which the micro device/system is to be formed. The base layer optionally undergoes mechanical micro machining such as ultra-precision milling, drilling, turning, or grinding, and/or non-mechanical micro machining including lithography and etching. Next, at least one layer of structural material is deposited on the micro-machined sacrificial layer. The structural layer then optionally undergoes mechanical and/or non-mechanical micro machining. Next, any excess material of the structural layer is removed. Finally, the material of the sacrificial layer is removed to at least partially free the final micro device/system from the base layer.

### CROSS REFERENCE TO RELATED APPLICATIONS

This application claims priority of U.S. Provisional Patent Application No. 60/253,496 filed Nov. 28, 2000 entitled METHOD OF MANUFACTURING ULTRA-PRECISE, SELF-ASSEMBLED MICRO SYSTEMS.

### STATEMENT REGARDING FEDERALLY SPONSORED RESEARCH OR DEVELOPMENT

N/A

### BACKGROUND OF THE INVENTION

The present invention relates generally to techniques for fabricating three-dimensional structures, and more specifically to a technique for fabricating three-dimensional structures that can be used to produce precisely machined self-assembled micro devices and micro systems.

Silicon-based techniques for fabricating micro devices and microstructures are known that employ layers of sacrificial and structural material in the fabrication process. One such silicon-based fabrication technique is bulk micro machining, which can be used to make a plurality of micro devices and/or microstructures in parallel on a silicon wafer. For example, bulk micro machining can be used to make Micro Electro Mechanical Systems (MEMS) and devices such as sensors and actuators. A conventional bulk micro machining process for fabricating a plurality of micro devices on a silicon wafer includes coating the wafer with a structural layer of thin oxide film, applying a sacrificial layer of photoresist on the thin oxide film, covering the photoresist layer with a masking layer that defines a plurality of predetermined device patterns, exposing the photoresist to ultraviolet light, developing the exposed photoresist for selectively exposing the thin oxide film according to the predetermined patterns of the masking layer, etching the exposed regions of the thin oxide film, and removing the sacrificial photoresist layer to expose the structural device patterns of the thin oxide film on the wafer. Next, the wafer is cut to separate the micro devices formed thereon. Each micro device is then integrated in a package that provides a suitable interface to the macro world.

Such conventional bulk micro machining fabrication processes can also be used to make microstructures such as trenches, slots, domes, membranes, and beams. For example, pluralities of beams and/or membranes can be fabricated on a silicon wafer by selectively doping the silicon substrate. Further, more complex micro devices and microstructures can be fabricated by performing bulk micro machining from both sides of the wafer and by wafer bonding, which comprises stacking a plurality of wafers.

However, conventional silicon-based techniques for fabricating micro devices and microstructures have drawbacks. For example, the transfer of etched patterns onto layers of structural material is inherently a low precision process, which can limit the complexity and functionality of the fabricated micro devices and microstructures. Further, it is generally difficult to fabricate non-planar, three-dimensional micro devices and microstructures using such silicon-based fabrication techniques. For example, it is particularly difficult to produce three-dimensional meso-scale device features that are normally required to provide mechanical interfaces between micro-scale device features and the macro-world. Still further, micro devices and microstructures that comprise silicon are typically only used in applications where temperatures are less than about 300° C. Moreover, conventional silicon-based fabrication techniques often have long development times.

High precision machining techniques for use in fabricating micro devices and microstructures are also known. For example, such high precision machining techniques comprise both mechanical micro machining techniques including milling, drilling, turning, and grinding, and non-mechanical micro machining techniques involving lithography and etching. Further, high precision machining techniques, particularly mechanical micro machining techniques, can facilitate the fabrication of three-dimensional micro devices and microstructures that include meso-scale device features.

However, conventional high precision machining techniques for fabricating micro devices and microstructures also have drawbacks. For example, such high precision machining techniques are typically only used to make individual device components, which must subsequently undergo micro assembly to produce a working micro device. Such micro device fabrication techniques that include fabricating a plurality of micro components and then assembling the micro components to produce the final micro device can be very complicated and can lead to high costs, especially for small production volumes.

It would therefore be desirable to have a technique for fabricating precisely machined micro devices and micro systems. Such a fabrication technique would facilitate the fabrication of non-planar three-dimensional device features. It would also be desirable to have a technique for fabricating micro devices and micro systems that reduces or eliminates the need for performing micro assembly to produce the final micro device or system.

### BRIEF SUMMARY OF THE INVENTION

In accordance with the present invention, a technique for fabricating precisely machined micro devices and micro systems is disclosed. Benefits of the presently disclosed micro fabrication technique are achieved by employing mechanical and/or non-mechanical ultra precision machining to shape selected layers of sacrificial and/or structural material to form the final micro device or system.

In one embodiment, the technique for fabricating precisely machined micro devices and micro systems includes providing a layer of base material on which the micro device/system is to be formed. The base material may constitute sacrificial or structural material or some other material that is not part of the final structure or assembly. The base, sacrificial, and structural materials may comprise metal, polymer, ceramic, semiconductor, or any other suitable material. The base layer optionally undergoes mechanical micro machining such as ultra-precision milling, drilling, turning, or grinding, and/or non-mechanical micro machining including lithography and etching. Next, a layer of sacrificial or structural material is deposited on the base layer. The sacrificial/structural layer then undergoes mechanical and/or non-mechanical micro machining. For example, this sacrificial/structural layer may undergo mechanical micro machining at least part way through the layer to form a surface conforming to the shape of at least one side of the micro device/system. Further, this sacrificial/structural layer may undergo non-mechanical micro machining to facilitate the formation of portions of the micro device/system that are too small to make using mechanical micro machining techniques. Next, at least one layer of sacrificial or structural material is deposited on the previous sacrificial/structural layer. This additional sacrificial/structural layer(s) then optionally undergoes mechanical and/or non-mechanical micro machining. Next, any excess material of the structural layer(s) is removed. Finally, the material of the sacrificial layer(s) is removed to at least partially free the final micro device/system from the base layer.

By employing ultra-precision machining to shape selected layers of sacrificial and/or structural material in a process for fabricating micro devices and micro systems, micro devices/systems can be made with device features that are highly three-dimensional. Further, such micro devices/systems can comprise structural features that range in size from the micro scale to the meso scale. Moreover, the technique for fabricating precisely machined micro devices/systems can not only be used to make individual device components but also fully assembled micro devices and micro systems.

Other features, functions, and aspects of the invention will be evident from the Detailed Description of the Invention that follows.

### BRIEF DESCRIPTION OF THE SEVERAL VIEWS OF THE DRAWING

The invention will be more fully understood with reference to the following Detailed Description of the Invention in conjunction with the drawings of which:

FIGS. 1a-1f depict sequential steps in fabricating a three-dimensional self-assembled micro device comprising a funnel according to the present invention;

FIGS. 2a-2f depict sequential steps in fabricating a thermal actuator using the micro device fabrication process illustrated in FIG. 1;

FIGS. 3a-3e depict sequential steps in fabricating an axial turbine using the micro device fabrication process illustrated in FIG. 1;

FIG. 4 depicts a comb drive fabricated using the micro device fabrication process illustrated in FIG. 1; and

FIG. 5 is a flow diagram depicting a method of fabricating three-dimensional self-assembled micro devices/systems according to the present invention.

### DETAILED DESCRIPTION OF THE INVENTION

U.S. Provisional Patent Application No. 60/253,496 filed Nov. 28, 2000 is incorporated herein by reference.

A method of fabricating precisely machined micro devices and micro systems is provided that can be used to make highly three-dimensional micro-scale and meso-scale device features while reducing or eliminating the need for final micro assembly. Such fabrication of three-dimensional self-assembled micro devices/systems is achieved by employing ultra precision machining to shape layers of sacrificial and/or structural material to form the final micro device/system. The sacrificial and/or structural layers can be shaped using mechanical micro machining techniques such as milling, drilling, turning, and grinding, and/or non-mechanical micro machining techniques involving lithography and etching. The order in which the sacrificial and structural layers are applied and optionally shaped depends on the configuration of the final micro device/system. The types of materials used to implement the sacrificial and structural layers can be chosen to meet performance and/or environmental requirements. For example, the sacrificial and structural layers may comprise metals (e.g., nickel (Ni), copper, (Cu), chromium (Cr), or zinc (Zn)), semiconductor materials (e.g., silicon), polymers, ceramics, or any other suitable material that is amenable to ultra precision machining. The presently disclosed micro fabrication technique can be used to make micro devices/systems including but not limited to Micro Electro Mechanical Systems (MEMS), devices, and structures such as scanners, linear/rotating actuators, mixers, reactors, pumps, flow sensors, gyroscopes, acceleration sensors, pressure sensors, radial/axial turbines, gears, comb drives, bone structures, membranes, channels, and beams.

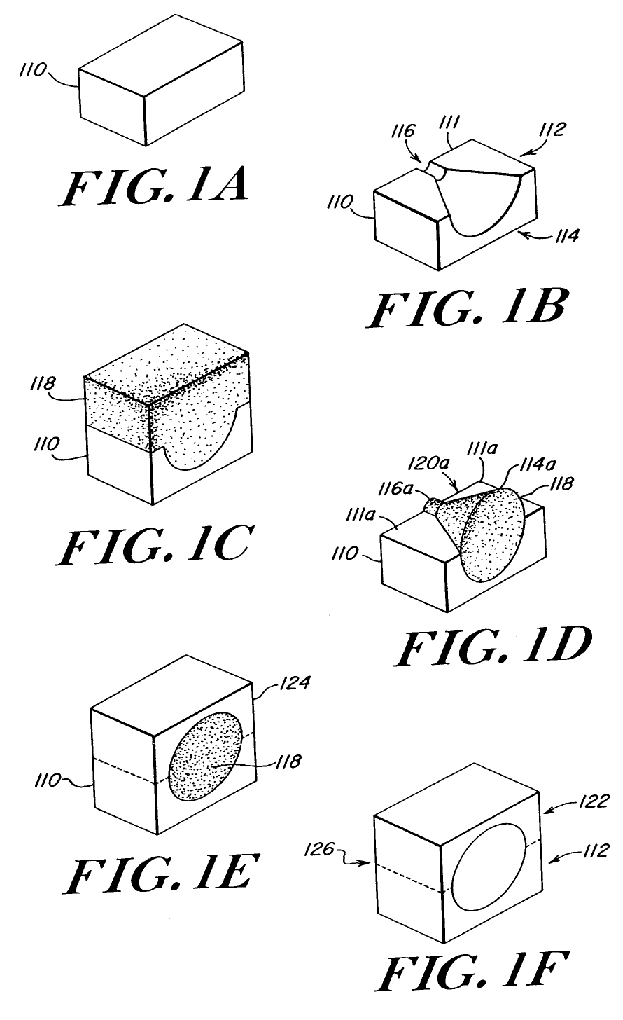

FIGS. 1a-1f depict sequential steps in fabricating a first exemplary micro device, namely, a three-dimensional self-assembled funnel having a meso-scale inlet and a micro-scale outlet, in accordance with the present invention. FIG. 1a depicts a first step of the micro device fabrication process, which comprises providing a raw block 110 of base material. In the presently disclosed micro fabrication technique, the base 110 constitutes a structural portion of the funnel. For example, the structural material of the base 110 may be a metal such as Ni. Accordingly, FIG. 1a shows a perspective view of the Ni base 110 used to form a portion of the structure of the funnel.

FIG. 1b depicts a second step of the micro device fabrication process, which comprises using ultra precision machining to shape the Ni base 110, thereby forming a first half 112 of the funnel. For example, a substantially planar surface 111 of the Ni base 110 may undergo mechanical micro machining such as micro milling. Accordingly, FIG. 1b shows a perspective view of the first half 112 of the funnel including a first half of a meso-scale inlet 114 and a first half of a micro-scale outlet 116.

FIG. 1c depicts a third step of the micro device fabrication process, in which a layer 118 of sacrificial material is deposited on the micro-machined surface 111 of the base 110. For example, the material of the sacrificial layer 118 may be a metal such as Cu, which may be deposited on the Ni base 110 by an electrolytic deposition process. It is noted that if the base surface were non-conductive, then a thin film of metal would be deposited on the base surface to render the surface conductive prior to electrolytic deposition. In alternative embodiments, sacrificial layers may be deposited on base portions or structural layers using alternative techniques such as electro-forming, thin film deposition, casting, or any other suitable deposition technique. It is further noted that the material of the sacrificial layer is chosen to be compatible with that of the structural layer to allow subsequent removal of the sacrificial layer from the structural layer without damaging the overall structure of the final micro device/system.

FIG. 1d depicts a fourth step of the micro device fabrication process, in which the sacrificial layer 118 undergoes ultra precision machining to form a surface 120a conforming to the shape of a second half 122 (see FIG. 1f) of the funnel. For example, the Cu sacrificial layer 118 may be shaped using micro milling. As shown in FIG. 1d, the surface 120a of the sacrificial layer 118 includes a portion 114a conforming to the shape of a second half of the meso-scale inlet 114 and a portion 116a conforming to the shape of a second half of the micro-scale outlet 116. Further, during micro milling of the sacrificial layer 118, the material of the sacrificial layer 118 is removed from portions 111a of the base surface 111 without damaging the base surface portions 111a.

FIG. 1e depicts a fifth step of the micro device fabrication process, in which a layer 124 of structural material is deposited on the micro-machined surface 120a of the sacrificial layer 118 and the base surface portions 111a by a suitable deposition process. The material of the structural layer 124 is the same as that of the base 110, e.g., Ni. Further, the structural layer 124 is deposited on the base surface portions 111a so that the base 110 and the structural layer 124 form an integrated piece 126 (see FIG. 1f).

FIG. 1f depicts a sixth step of the micro device fabrication process, in which the remaining material of the sacrificial layer 118 is removed from the integrated structure of the funnel 126. For example, the sacrificial layer 118 may be removed by etching. As mentioned above, the Cu material of the sacrificial layer 118 is chosen to be compatible with the Ni material of the base 110 and the structural layer 124 to allow the sacrificial layer 118 to be removed without damaging the overall structure of the funnel 126. As shown in FIG. 1f, the funnel 126 including the three-dimensional meso-scale inlet 114 and micro-scale outlet 116 requires no micro assembly.

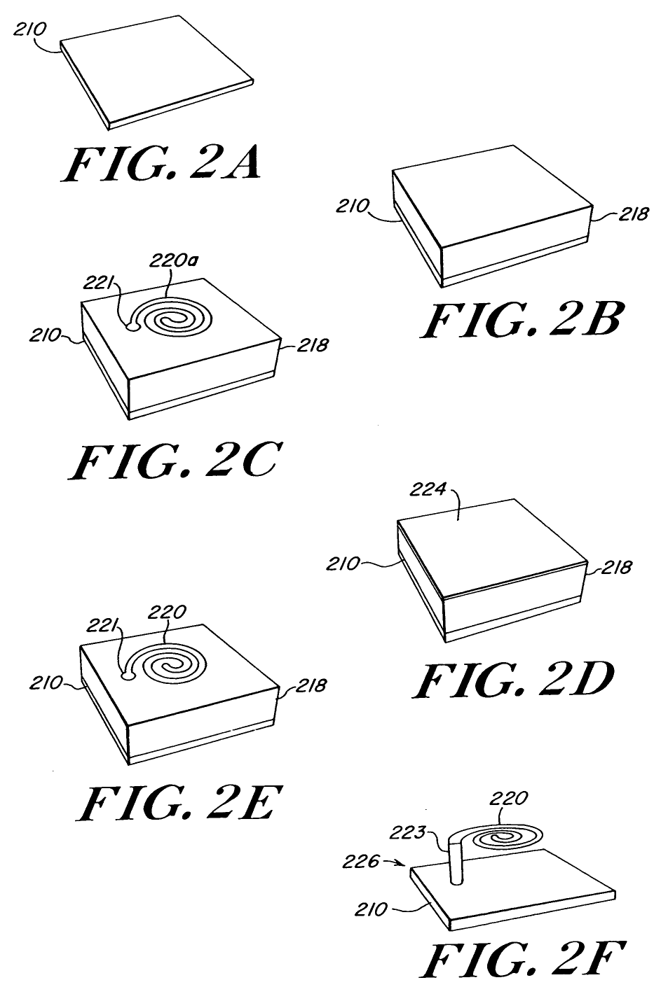

FIGS. 2a-2f depict sequential steps in fabricating a second exemplary micro device, namely, a three-dimensional self-assembled thermal actuator. FIG. 2a depicts a first step of the thermal actuator fabrication process, in which a substrate 210 of base material is provided. For example, the base material may be a metal such as Ni.

FIG. 2b depicts a second step of the thermal actuator fabrication process, in which a layer 218 of sacrificial material is deposited on the Ni substrate 210. For example, the material of the sacrificial layer 218 may be a metal such as Cu, which may be deposited on the Ni substrate 210 using an electrolytic deposition process.

FIG. 2c depicts a third step of the thermal actuator fabrication process, in which a hole 221 is drilled through the Cu sacrificial layer 218 to the Ni substrate 210. Further, the sacrificial layer 218 undergoes ultra precision machining to form a surface 220a conforming to the shape of a spiral structure 220 (see FIGS. 2e and 2f). For example, the hole 221 may be drilled through the sacrificial layer 218 using a micro drilling technique and the surface 220a conforming to the shape of the spiral 220 may be formed using a flat micro milling technique. As shown in FIG. 2c, the outer end of the spiral surface 220a is disposed at the opening of the hole 221. It is noted that different sizes of the spiral surface 220a may be made using micro milling tools of various sizes, e.g., 0.3 mm, 0.7 mm, and 1.2 mm.

FIG. 2d depicts a fourth step of the thermal actuator fabrication process, in which a layer 224 of structural material is deposited on the micro-machined sacrificial layer 218 by a suitable deposition process.

The material of the structural layer 224 is the same as that of the substrate 210, e.g., Ni. In alternative embodiments, the respective materials of the substrate 210 and the structural layer 224 may be different. For example, the substrate 210 may be steel and the structural layer 224 may be Ni. The structural layer 224 is deposited on the sacrificial layer 218 to cover the surface of the sacrificial layer 218 including the spiral surface 220a and fill the hole 221 extending through the sacrificial layer 218 to the substrate 210. The material of the structural layer 224 covers the spiral surface 220a to form the spiral structure 220 and fills the hole 221 to make contact with the substrate 210, thereby forming an integrated piece 226 (see FIG. 2f).

FIG. 2e depicts a fifth step of the thermal actuator fabrication process, in which excess material of the structural layer 224 is removed from the sacrificial layer 218. Specifically, excess material of the structural layer 224 is removed from the surface of the sacrificial layer 218 surrounding the spiral structure 220 and the opening of the hole 221. For example, the excess structural material may be removed from the sacrificial layer 218 by micro milling.

FIG. 2f depicts a sixth step of the thermal actuator fabrication process, in which the material of the sacrificial layer 218 is removed from the integrated structure of the thermal actuator 226. For example, the sacrificial layer 218 may be removed by etching. The Cu material of the sacrificial layer 218 is chosen to be compatible with the Ni material of the structural layer 224 to allow the sacrificial layer 218 to be removed without damaging the overall structure of the thermal actuator 226. As shown in FIG. 2f, the fully assembled thermal actuator 226 is a highly three-dimensional structure comprising the spiral 220 suspended over the substrate 210 by a post 223.

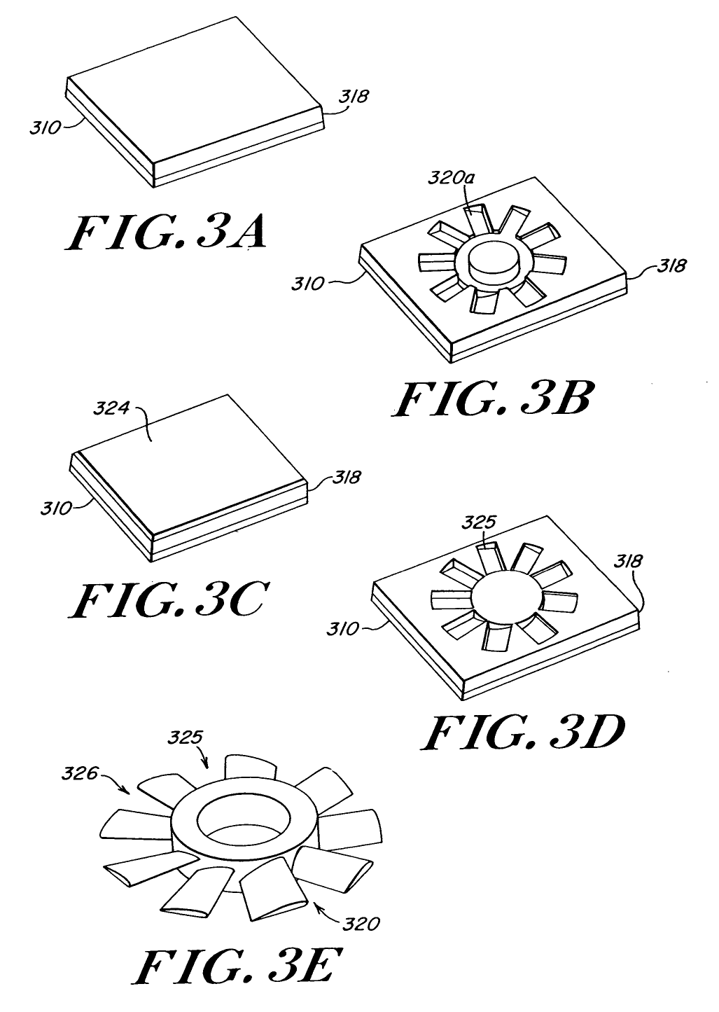

FIGS. 3a-3e depict sequential steps in fabricating a third exemplary micro device, namely, a three-dimensional self-assembled axial turbine. As shown in FIG. 3a, a first step of the axial turbine fabrication process includes providing a substrate 310 of base material, and depositing a layer 318 of sacrificial material on the substrate 310. For example, the base material may be a metal such as Ni. Further, the material of the sacrificial layer 318 may be a metal such as Cu and may be deposited on the Ni substrate 310 by an electrolytic deposition process.

A second step of the axial turbine fabrication process, as depicted in FIG. 3b, includes ultra precision machining the sacrificial layer 318 to form a mold comprising a surface 320a that conforms to the shape of a first side 320 of the axial turbine structure 326 (see FIG. 3e). For example, the molded surface 320a may be formed by micro milling.

A third step of the axial turbine fabrication process, as depicted in FIG. 3c, includes depositing a layer 324 of structural material on the micro-machined sacrificial layer 318 by a suitable deposition process. The material of the structural layer 324 may be the same as the substrate 310, e.g., Ni. The structural material is deposited on the sacrificial layer 318 to fill the molded surface 320a of the sacrificial layer 318.

A fourth step of the axial turbine fabrication process, as depicted in FIG. 3d, includes ultra precision machining the structural layer 324 to form a second side 325 (see also FIG. 3e) of the axial turbine structure 326. For example, the second side 325 of the axial turbine may be formed by micro milling.

A fifth step of the axial turbine fabrication process, as depicted in FIG. 3e, includes removing the material of the sacrificial layer 318 from between the substrate 310 and the structural layer 324. For example, the sacrificial layer 318 may be removed by etching. Further, the Cu material of the sacrificial layer 318 is removed without damaging the Ni structure of the axial turbine 326. As shown in FIG. 3e, the sacrificial layer 318 is removed to free the three-dimensional self-assembled axial turbine 326 from the base substrate 310. It is noted that the final axial turbine 326 has a blade angle and profile geometry that are difficult to achieve using conventional micro device fabrication techniques.

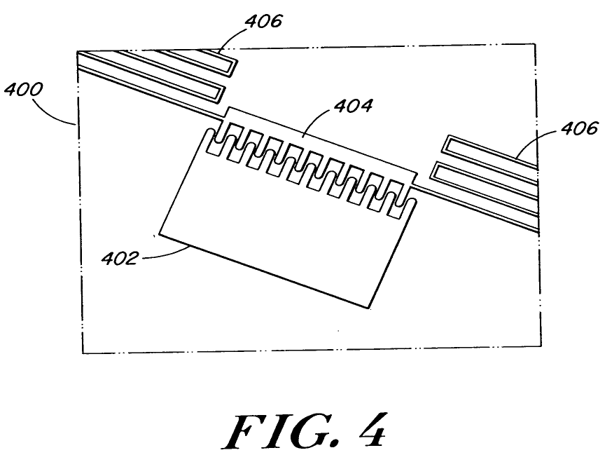

It should be understood that the micro device fabrication techniques employed in the above-described examples can be combined with conventional techniques that include lithography and etching. For example, the presently disclosed micro fabrication technique can be used to make a three-dimensional self-assembled comb drive 400 (see FIG. 4), which is a MEMS device that can act as a sensor or an actuator in, e.g., optical scanners, air bags, and optical switches.

As shown in FIG. 4, the comb drive 400 includes a fixed comb portion 402 and a movable comb portion 404, which is attached to a spring 406. A voltage is applied between the fixed and movable combs 402 and 404, thereby generating an electric field between the combs 402 and 404. In the event the comb drive 400 is configured as sensor, a displacement of the movable comb 404 causes a change in the electric field between the fixed comb 402 and the movable comb 404, thereby changing the voltage between the combs 402 and 404. By measuring this change in voltage, the amount of displacement of the moveable comb 404 can be determined. In the event the comb drive 400 is configured as an actuator, the voltage applied between the combs 402 and 404 can be increased to create motion in the movable comb 404.

The above-described micro fabrication technique that combines mechanical micro machining with sacrificial/structural fabrication processes can be used to make the fixed comb 402 and/or the movable comb 404 portions of the comb drive 400, while conventional lithography technology can be used to make the spring 406, which is typically too small to make with mechanical micro machining. By combining mechanical micro machining techniques such as milling, drilling, turning, and grinding with conventional lithography and etching techniques, larger comb drives with higher performance capabilities can be achieved.

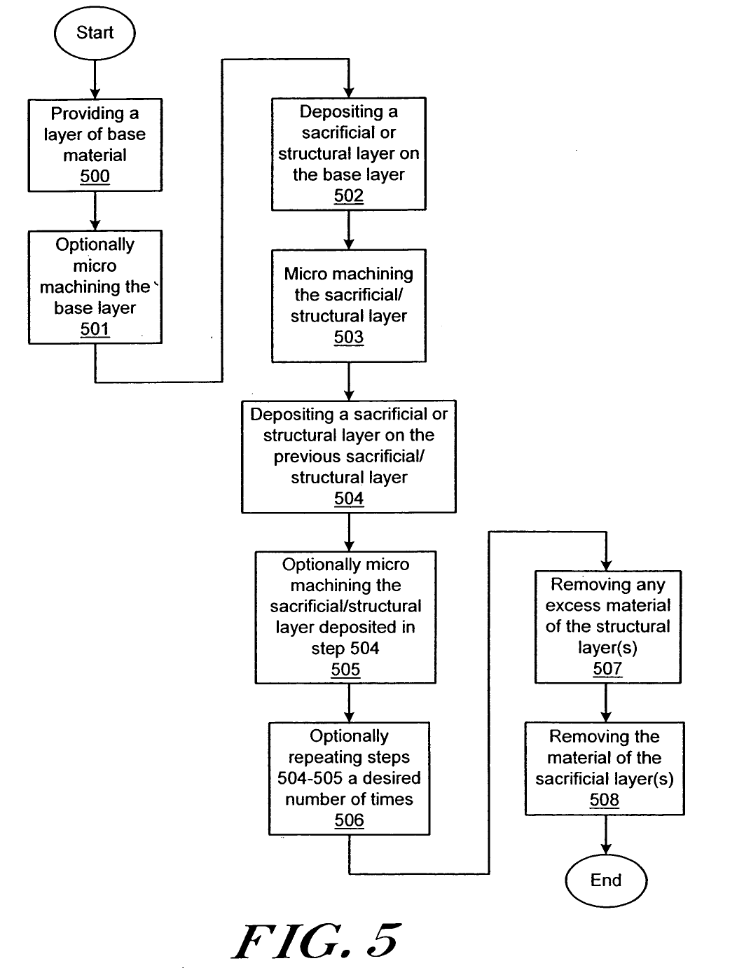

The presently disclosed method of fabricating three-dimensional self-assembled micro devices and micro systems is illustrated by reference to FIG. 5. As depicted in step 500, a layer of base material is provided on which the micro device/system is to be formed. It is noted that the base layer may comprise sacrificial or structural material, or some other material that is not part of the final micro device/system structure or assembly. Next, the base layer optionally undergoes, as depicted in step 501, mechanical micro machining such as ultra-precision milling, drilling, turning, or grinding, and/or non-mechanical micro machining such as lithography/etching. A layer of sacrificial or structural material is then deposited, as depicted in step 502, on the base layer. Next, this sacrificial/structural layer undergoes, as depicted in step 503, mechanical and/or non-mechanical micro machining. A layer of sacrificial or structural material is then deposited, as depicted in step 504, on the previous sacrificial/structural layer. Next, the sacrificial/structural layer deposited in step 504 optionally undergoes, as depicted in step 505, mechanical and/or non-mechanical micro machining. Steps 504 and 505 are then optionally repeated, as depicted in step 506, a desired number of times depending on the configuration of the final micro device/system. Any excess material of the structural layer(s) is then removed, as depicted in step 507. Finally, the material of the sacrificial layer(s) is removed, as depicted in step 508, thereby at least partially freeing the final micro device/system from the base layer. It should be appreciated that the above-described method can be repeated any number of times to create highly complex MEMS and other micro systems.

It will further be appreciated by those of ordinary skill in the art that modifications to and variations of the above-described method of manufacturing ultra-precise, self-assembled micro-devices and systems may be made without departing from the inventive concepts disclosed herein. Accordingly, the invention should not be viewed as limited except as by the scope and spirit of the appended claims.

What is claimed is:

1. A method of fabricating a three-dimensional self-assembled micro device or micro system, comprising the steps of:
providing a layer of base material on which the micro device or micro system is to be formed;
depositing at least one layer of sacrificial material on the base layer;
performing mechanical micro machining on the sacrificial layer to form at least one surface conforming to a shape of at least one first portion of the micro device or micro system;
depositing at least one layer of structural material on the micro-machined sacrificial layer to form the at least one first portion of the micro device or micro system; and
removing the layer of sacrificial material to at least partially free the micro device or micro system from the base layer.

2. The method of claim 1 further including the step of performing mechanical micro machining on the base layer to form at least one second portion of the micro device or micro system.

3. The method of claim 1 further including the step of performing mechanical micro machining on the structural layer to form at least one second portion of the micro device or micro system.

4. The method of claim 1 further including the step of removing any excess material of the structural layer.

5. The method of claim 1 wherein the first depositing step includes depositing the at least one layer of sacrificial material, the material of the sacrificial layer being selected from the group consisting of metal, polymer, ceramic, and semiconductor material.

6. The method of claim 1 wherein the second depositing step includes depositing the at least one layer of structural material, the material of the structural layer being the same as that of the base layer.

7. The method of claim 1 wherein the second depositing step includes depositing the at least one layer of structural material, the material of the structural layer being selected from the group consisting of metal, polymer, ceramic, and semiconductor material.

8. The method of claim 1 wherein the performing step includes performing precision milling, drilling, turning, or grinding on the sacrificial layer.

9. The method of claim 8 wherein the performing step further includes performing non-mechanical micro machining on the sacrificial layer.

10. The method of claim 9 wherein the performing step includes performing lithography and etching on the sacrificial layer.

11. The method of claim 3 wherein the second performing step includes performing precision milling, drilling, turning, or grinding on the structural layer.

12. The method of claim 11 wherein the second performing step further includes performing non-mechanical micro machining on the structural layer.

13. The method of claim 12 wherein the second performing step includes performing lithography and etching on the structural layer.

14. The method of claim 1 wherein the first depositing step includes depositing the at least one layer of sacrificial material on the base layer by electrolytic deposition, electro-forming, thin film deposition, or casting.

15. The method of claim 4 wherein the second removing step includes removing the excess material of the structural layer by a mechanical micro machining process.

16. The method of claim 1 wherein the removing step includes removing the layer of sacrificial material by an etching process.

17. The method of claim 1 wherein the providing step includes providing the layer of base material, the material of the base layer being selected from the group consisting of sacrificial material, structural material, and a predetermined material that is not part of the micro device or micro system.
